(19) United States
(12) Patent Application Publication
(10) Pub. No.: US 2012/0231823 A1
(43) Pub. Date: Sep. 13, 2012

(54) METHOD FOR MANAGING MESSAGE SUITABLE FOR MOBILE APPARATUS AND HOST

(75) Inventor: Gary Kung, Santa Ana, CA (US)

(73) Assignee: I/O INTERCONNECT, LTD., Santa Ana, CA (US)

(21) Appl. No.: 13/241,708

(22) Filed: Sep. 23, 2011

Related U.S. Application Data
(60) Provisional application No. 61/451,781, filed on Mar. 11, 2011.

(51) Int. Cl. H04W 4/14; H04W 4/12

(52) U.S. Cl. 455/466

(57) ABSTRACT

A method for controlling the mobile apparatus is provided by the present invention. First, a data transmission link with a host group is built. When the mobile apparatus receives a coming message from a communication end, a notification message is sent to the host group through the data transmission link, so as to notify a user.

### CROSS-REFERENCE TO RELATED APPLICATIONS

The application claims priority of U.S. provisional patent application Ser. No. 61/451,781 filed on Mar. 11, 2011, the contents of which are hereby incorporated by reference.

### FIELD OF THE INVENTION

The present invention relates to a method for managing message, and more particularly to a method for managing message between a mobile apparatus and a host group.

### BACKGROUND OF THE INVENTION

Following the wireless communication technology has great development recent years, almost everyone has a mobile apparatus, such as mobile phone or smart phone. In the application of mobile phone, the utility rate of message transmission is only inferior to the utility rate of dialing. In such situation, when the mobile phone receives a coming message, such a SMS message or a MMS message, the user may be unable to read the message immediately if not carrying the mobile phone. This situation is inconvenience for most users.

### SUMMARY OF THE INVENTION

The present invention provides a method for controlling a mobile apparatus and an operation method for a host apparatus for managing the message.

A method for controlling the mobile apparatus is provided by the present invention. First, a data transmission link with a host group is built. When the mobile apparatus receives a coming message from a communication end, a notification message is sent to the host group through the data transmission link, so as to notify a user.

From another view point, an operation method is provided by the present invention. First, a data transmission link is accepted by a host apparatus for responding a linking requirement from the mobile apparatus. When the host apparatus receives a notification message through the mobile apparatus through the data transmission link, the host apparatus would notify a user that the mobile apparatus receives a coming message sent from a communication end.

Since the present invention would send the notification message to the host group as the mobile apparatus receiving the coming message, the user can read the coming message immediately.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a system block diagram of a mobile apparatus according to one preferred embodiment of the present invention.

FIGS. 2A and 2B are illustrated a flow chart of a method for managing message according to one preferred embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

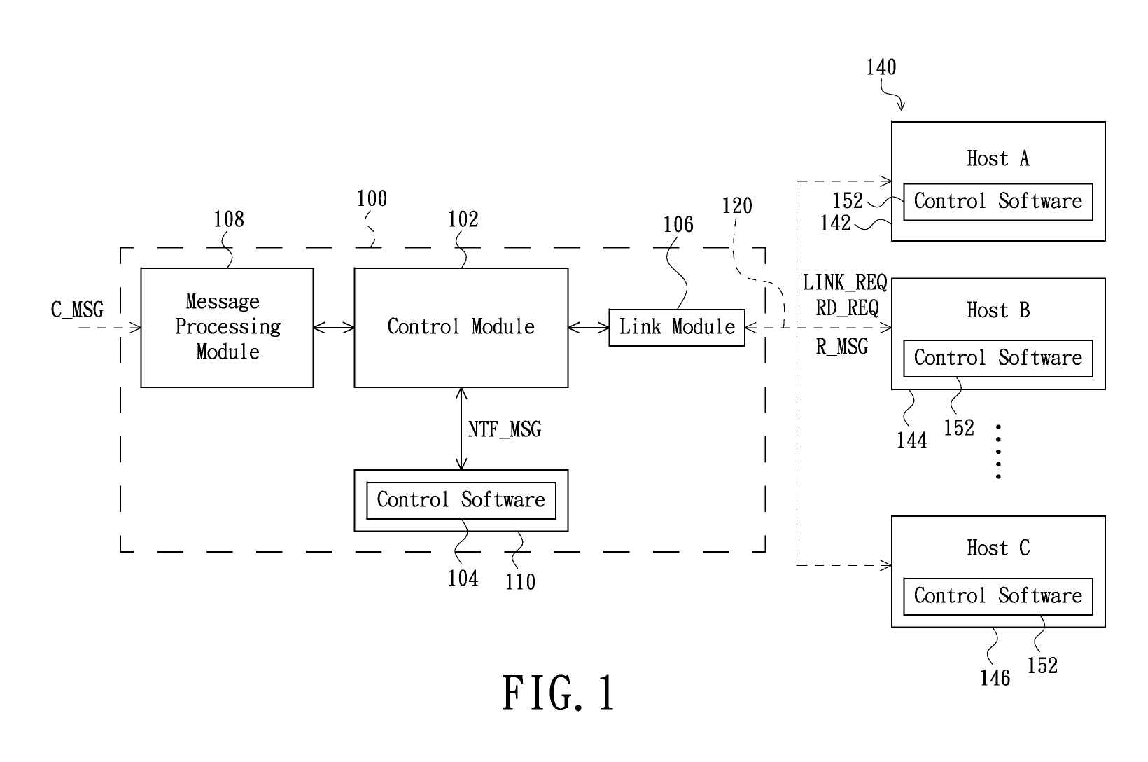

FIG. 1 is a system block diagram of a mobile apparatus and a host group according to one preferred embodiment of the present invention. Referring to the FIG. 1, the mobile apparatus 100 of the present invention can link with a host group 140 through a data transmission interface 120. In some embodiments, the data transmission interface 120 is probably a wireless transmission interface, such like WiFi, a 3G, a 4G, an infrared, or a Bluetooth transmission interface.

In addition, the host group 140 comprises at least one host. In this embodiment, the host group 140 has a plurality of hosts, such as host A 142, host B 144, and host C 146. The hosts in the host group are desktop computer, notebook computer, package computer and/or tablet computer.

The mobile apparatus 100 of the exemplary embodiment comprises a control module 102, a control software 104, a link module 106, and a message processing module 108. The control module 102 communicates with the control software 104, and couples to the link module 106 and message processing module 108. In some embodiments, the control software 104 is implemented by an application program, and installed into a storage unit 110. Wherein, the storage unit 110 is a build-in storage device, such as internal hard disk or a flash memory, for coupling to the control module 102.

Except the control software 104, a plurality of control software 152 are configured into the hosts in the host group 140. Similarly, each control software 152 is also probably implemented by an application program. In this exemplary embodiment, the control software 104 and 152 form a message management system. In this exemplary embodiment, when the control software 104 is started, the control software 104 would establish a data link with the host group 140 by using the data transmission interface 120.

Additionally, the link module 106 is configured for linking to the host group 140 through the data transmission interface 120. In some embodiments, the link module 106 is probably a WiFi processing unit, a 3G communication unit, a 4G communication unit, an infrared transmission unit, or a Bluetooth transmission unit. In other embodiments, the link module 106 has a connection port, such as a USB port, for connecting with a transmission line to link to the host group 140, and the data transmission interface 120 is therefore a transmission line, such as a USB line, in that embodiment.

When the control software 104 is started, the control software 104 would send a link requirement LINK_REQ to the host group 140 through the link module 106 and the data transmission interface 120, so as to build a data transmission link with the host group 140. When the hosts 142, 144 or 146 receives the link requirement LINK_REQ, the corresponding one of the control software 152 would accept the data transmission link for responding the link requirement LINK_REQ.

Furthermore, the message processing module 108 is configured for receiving a message from or sending a message to a communication end. The received or sent messages are any messages such like SMS message or MMS message that can be processed by the mobile apparatus 100. When the message processing module 108 receives a coming message C_MSG from a communication end, the coming message C_MSG would be sent to the control module 102 from the message processing module 108. The control module 102 informs the control software that a message is received, and the control software 104 would generate a notification message NTF_MSG back to the control module 102. Then, the control module 102 sends the notification message NTF_MSG to the link module 106, so as to transmit the notification message NTF_MSG to the host group 140 via the data transmission link.

When the notification message NTF_MSG is sent to the host group 140, each of the control software 152 would control the hosts 142, 144 and 146 to notify the user that the mobile apparatus 100 receives the coming message. For example, the control software 152 can show a notification window on screens of corresponding host apparatuses 142, 144 and 146. In some embodiments, the control software 152 further control the hosts 142, 144 and 146 to generate a speech sound or an alarm sound to notify the user.

Meanwhile, when the user wants to read the coming message C_MSG through one of the hosts 142, 144 and 146 in the host group 140, the user can operate corresponding host to control the control software 152 to generate a message-read requirement RD_REQ. Therefore, the control software 104 would receive the message-read requirement RD_REQ from the data transmission link and ask the control module 102 to send the coming message C_MSG to the link module 106, so as to transmit the coming message C_MSG to the host group 140 through the data transmission interface 120 for responding the message-read requirement RD_REQ. So that, the user can read the coming message without switching different equipments.

In addition, the message management system provided by the exemplary embodiment allows the user replying the coming message on one of hosts 142, 144 and 146. In some embodiment, the control software 152 provides an edition window on a display apparatus of each of hosts in the host group 140. If the user wants to reply the coming message, the user can operate one of the hosts 142, 144 and 146 to edit a reply message R_MSG through the edition window. When the user completes the reply message R_MSG, the control software 152 would send the reply message R_MSG to the mobile apparatus 100 from the host group 140 via the data transmission interface 120. Then, the link module 106 would obtain the reply message R_MSG from the data transmission interface 120 and send the reply message R_MSG to the control module 120. Meanwhile, the message processing module 108 is controlled to send the reply message R_MSG to the communication end. Therefore, the user is unnecessary to switch different equipments to reply the coming message.

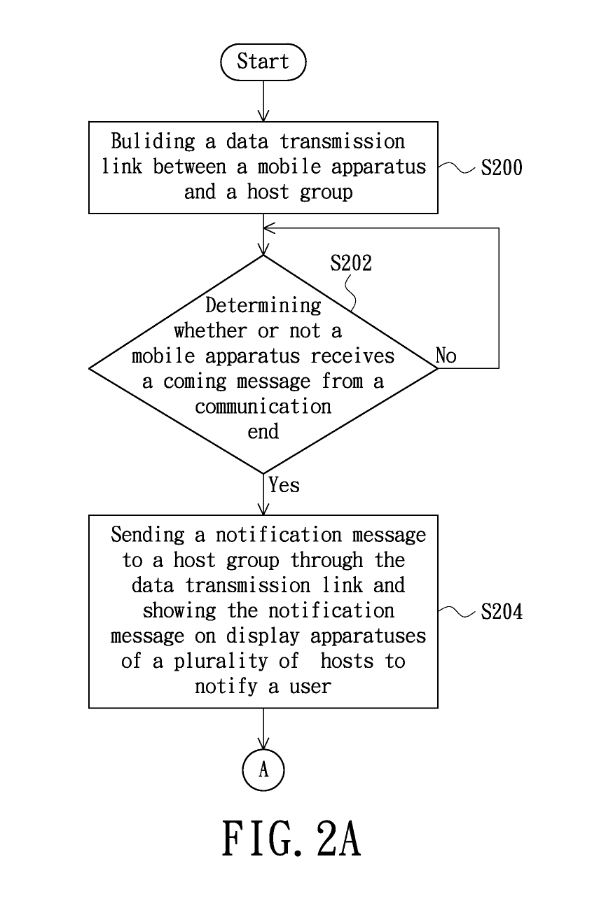

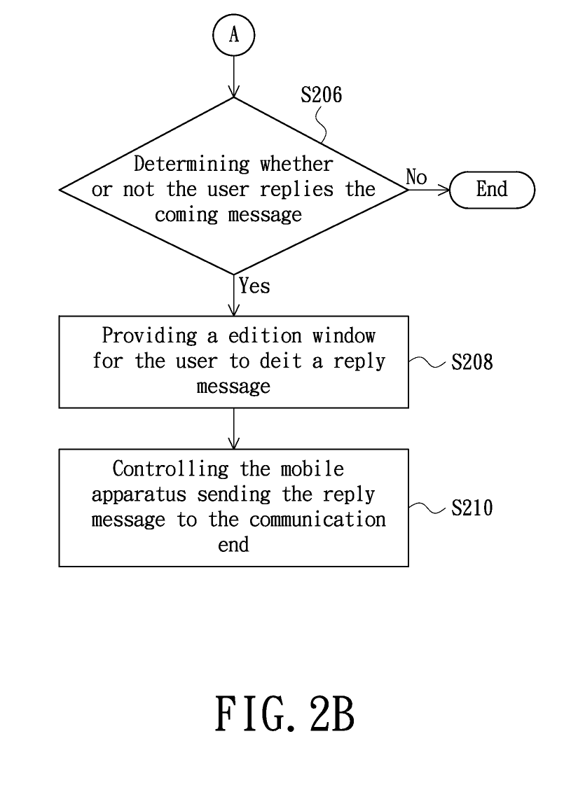

FIGS. 2A and 2B are illustrated a flow chart of a method for managing message according to one preferred embodiment of the present invention. Referring to the FIG. 2A first, the method would build a data transmission link between a mobile apparatus and a host group, as the description in the step S200, wherein the host group has at least one host apparatus. Then, the step S202 is performed to determine whether or not the mobile apparatus receives a coming message from a communication end. If the mobile apparatus receives the coming message (i.e., “Yes” labeled on the step S202), the step S204 is performed to send a notification message to the host group through the data transmission link and show the notification message on the display apparatuses of a plurality of hosts to notify a user.

Then, referring to the FIG. 2B, as the description in the step S206, the method determines whether or not the user replies the coming message. When the user chooses replying the coming message (i.e., “Yes” labeled on the step S206), the method provides an edition window for the user to edit a reply message, as description in the step S208. Then, as the description in the step S210, the mobile apparatus is controlled to send the reply message to the communication end.

In summary, the present invention would notify the user that the mobile apparatus receives a coming message. Therefore, the user may read the coming message more immediately. In addition, the present invention would send the coming message to the host from the mobile apparatus, and allow the user editing the reply message on the host and control the mobile apparatus to send the reply message. So that, the present invention can make the user read and reply the message without switching different equipments.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for controlling a mobile apparatus, comprising:
building a data transmission link with a host group; and
sending a notification message to the host group through the data transmission link for notifying a user as receiving a coming message from a communication end.

2. The method according to claim 1, further comprising:
sending the coming message to the host group for responding a message-read requirement from the host group.

3. The method according to claim 1, further comprising:
controlling the mobile apparatus to send a reply message edited by the user to the communication end as receiving the reply message from the host group.

4. The method according to claim 3, wherein the reply message is a SMS message or a MMS message.

5. The method according to claim 1, wherein the coming message is a SMS message or a MMS message.

6. An operation method for a host apparatus, comprising:
accepting a data transmission link for responding a linking requirement from a mobile apparatus; and
notifying a user that the mobile apparatus receives a coming message sent from a communication end, when the host apparatus receives a notification message from the mobile apparatus through the data transmission link.

7. The operation method according to claim 6, further comprising:
receiving a reply message from the user;
sending the reply message to the mobile apparatus through the data transmission link; and
sending a control command to the mobile apparatus through the data transmission link, so as to make the mobile apparatus sending the reply message to the communication end.

8. The operation method according to claim 7, wherein the reply message is a SMS message or a MMS message.

9. The operation method according to claim 7, further comprising:
providing an edition window for the user to edit the reply message.

10. The operation method according to claim 6, wherein the step of notifying the user comprises:
generating at least one of a notification window on a screen of the host apparatus, a speech sound and an alarm sound to notify the user.

11. The operation method according to claim 6, further comprising:
generating a message-read requirement to the mobile apparatus to obtain the coming message; and
show the content of the coming message on a screen of the host apparatus.

12. The operation method according to claim 6, the coming message is a SMS message or a MMS message.
